(19) United States
(12) Patent Application Publication
(10) Pub. No.: US 2014/0161433 A1
(43) Pub. Date: Jun. 12, 2014

(54) CAMERA MOUNT FOR A SKIER

(71) Applicant: Maximilian Steinhauser, Lienz (AT)

(72) Inventor: Maximilian Steinhauser, Lienz (AT)

(21) Appl. No.: 14/131,415

(22) PCT Filed: Apr. 27, 2012
(86) PCT No.: PCT/EP2012/057846

§ 371 Date: Jan. 7, 2014

(30) Foreign Application Priority Data
Jul. 8, 2011 (DE) 10 2011 078 901.4

(51) Int. Cl. G03B 17/56

(52) U.S. Cl. CPC G03B 17/561
USPC 396/420

(57) ABSTRACT

The present invention relates to a system for attaching a camera to a user. The system comprises a baseplate, a holding rod attached to the baseplate, and an attachment device attached to the holding rod. The attachment device is designed in such a way that the camera can be attached thereto. The baseplate is designed in such a way that it can be attached to a back device that can be attached to the user's back.

### CROSS-REFERENCE TO RELATED APPLICATION

This application is a National Phase Patent Application of International Patent Application Number PCT/EP2012/057846, filed on Apr. 27, 2012, which claims priority to German Patent Application Number 10 2011 078 901.4, filed on Jul. 8, 2011, the disclosures of which are hereby incorporated by reference in their entireties.

### FIELD OF THE INVENTION

The present invention relates to a system for attaching a camera to a user as well as a method for imaging a user.

### TECHNOLOGICAL BACKGROUND

In the area of mountain sports such as, for example, during skiing or climbing, sportsmen such as, for example, skiers or climbers, frequently have a need to record themselves during skiing or climbing. Specifically during skiing or climbing, it is however necessary to attach the recording camera in order to have both hands available for skiing or for climbing.

For example, it is known to attach a camera to a helmet or to a holding device attached to the head. In this case however, it is not the sportsman who is recorded, but only the field of view of the sportsman. Since the sportsman executes rapid movements with his head, this leads to blurred and jittery camera recordings.

Furthermore, the user usually looks along a slope parallel and turns his head accordingly, so that the actual ascent or the actual drop is not reflected on the image.

US 2007/0160364 A1 discloses a side arm which can be mounted on a wheel, on the end of which a camera is installed. The side arm is attached to a frame of a bicycle. Even with such a camera mount, jittery recordings are generated since on the one hand the bicycle, for example, when going round a bend, slopes and in addition, impacts produced when riding over uneven ground are transmitted to the camera.

### SUMMARY OF THE INVENTION

There may be a need to provide a mount for a camera which does not restrict the user in his movement and attaches the camera in such a manner that the movement sequences of the user can be recorded by the camera.

According to a first aspect of the present invention, a system is provided for mounting a camera on a user (sportsman) such as, for example, a skier, a freerider, a climber or a mountain bike rider, in particular a downhill rider. The system comprises a base plate, a holding rod and an attachment device. The holding rod is attached to the base plate and the attachment device is attached to the holding rod. The attachment device is configured in such a manner that the camera is attachable thereon. The base plate is configured in such a manner that this is attachable to a back device which is attachable to a user's back.

According to a further aspect of the present invention, a method for imaging a user, for example, a skier or a climber, is described. According to the method, an image of a user is recorded by a camera, wherein the camera is attached to an attachment device. The attachment device is attached to a holding rod which is attached to a base plate. The base plate is attachable to a back device attached to a user's back.

The back device describes a device which can be fastened to a user's back, e.g. by carrying loops. The back device is, for example, a rucksack, a back protector or the like.

The base plate which is attachable to the back device is configured to transfer a force, such as for example the weight force of the camera, and moments which are produced, for example by the weight force of the camera at the attachment site of the holding rod to the base plate. A stable attachment of the camera to the back device is provided by the base plate since the base plate has a large contact area with the back device. The back device is in contact with the user with a first contact side and in contact with the base plate with a side opposite the first side. The base plate is configured in such a manner that for example, at least half the second area of the back device is covered by the base plate. The base plate for example has a rectangular shape with a side length of about 20 cm to about 65 cm, in particular of about 35 cm-45 cm×about 15 cm to 25 cm (centimetres). The base plate has an area of about 500 cm² to 4500 cm², in particular of about 1000 cm².

The base plate has a supporting surface for supporting on the back device, wherein the supporting surface is at least twice as large as the cross-sectional area of the cross-section of the holding rod and/or a further supporting surface of the holding rod on the base plate. The supporting surface of the base plate can further be at least three times, four times or, for example, ten times as large as the cross-sectional area of the cross-section of the holding rod and/or the further supporting surface of the holding rod on the base plate.

The base plate is further configured to be low-weight. Thus, the base plate can be made, for example, of fibre composite materials such as, for example, carbon fibre materials or glass fibre materials. Furthermore the base plate can have recesses to save weight. The size of the supporting surface of the base plate on the back device is defined by the edge of the base plate, where the edge can be configured to be continuous or to have gaps. Furthermore, the base plate can have regions of different material thickness so that in highly stressed areas a greater material thickness is used than in regions having a comparatively less high stressing. Thus, for example, the base plate can, for example, have a greater material thickness in its attachment region to the holding rod compared to regions which are not in contact with the holding rod.

The holding rod is configured to space apart the camera from the base plate in such a manner that the camera records images which show the user and the foreground of the user. The holding rod can, for example, be longer than about 30 cm. The holding rod can, for example, have a length of about 30 cm to about 1 m, in particular about 50 cm to about 60 cm. Furthermore, the holding rod can be made of light-weight materials such as, for example, aluminium or fibre composite materials. The holding rod can be one-piece or consist of a plurality of detachably connected elements. Furthermore, the holding rod can be configured to be retractable and extendable in a telescopic manner. The holding rod and the base plate can be separate elements which are connected to one another, for example, by a material connection (gluing) or by a fastening means (e.g. screws).

The attachment device comprises, for example, a fastening plate or a clamping device so that the camera can be (detachably) attached by a suitable fastening means (e.g. by a hook and loop fastener or by holding straps). Furthermore the attachment device can have a casing into which the camera is inserted and thus is attachable. The casing can have transparent areas and additionally can be configured to be splash-proof or waterproof.

The elements of the system such as for example the base plate, the holding rod and the attachment device is attachable detachably and exchangeably to one another so that the individual elements can be dismantled after use and can be stowed in a space-saving manner in the back device such as for example the rucksack. Alternatively the elements of the system such as, for example, the base plate, the holding rod and the attachment device can be formed integrally and in one piece. Thus, a stiffer and more stable combination of elements can be created.

The camera is, for example, a film (video) camera and/or an imaging camera. As a result of the camera being spaced apart from the back of the user by the holding rod, an extraordinary camera perspective is created, where the camera records images or films which show at least a partial section of the user and additionally the foreground of the user. Thus, for example compared with helmet cameras or cameras held near the chest, the user can record his movement sequences and at the same time, obtain the reference foreground, which is frequently so important for sports recordings, in the field of view of the camera. Since the camera is attachable to the back of the user or to a back device, the camera is almost always perpendicular so that the terrain or the hill slope is better represented on a recorded photograph. With a helmet camera on the other hand, the user is frequently looking down a slope so that the impression is given that the slope is flat. By the present invention, the user can act simultaneously as filmer and actor (sportsman).

According to a further exemplary embodiment, the base plate has at least one through opening and/or at least one loop so that the base plate is attachable to the back device by a holding strap.

The holding strap can, for example, be firmly connected to the back device at one end and be guided through the through-opening of the base plate so that after tightening the holding strap, the base plate is attached firmly to the back device. Furthermore, the holding strap can be guided through the through-opening and/or through the loop and enclose the entire back device so that after tightening the strap, a clamping connection exists between the base plate, the loop and the back device. A plurality of straps can be used for attachment of the base plate. According to the number of holding straps, the base plate can further have a plurality of through openings and/or loops.

According to a further exemplary embodiment, the holding rod is attached pivotally to the base plate. For example, the holding rod is attachable pivotably to the base plate by a bolt, in particular by a stud. The bolt can, for example, be attached rotatably in a corresponding receiving opening of the base plate. By pivoting of the holding rod, the attachment device is co-pivoted accordingly so that a desired camera position is adjustable.

According to a further exemplary embodiment, the holding rod and the base plate configure a plug connection in such a manner that the holding rod is pivotable about the bolt.

For example, the holding rod has a groove and the base plate has a bolt. The groove and the bolt are configured in such a manner that these form the plug connection so that the holding rod is pivotable about the bolt. Alternatively the holding rod and base plate can have a groove.

By the groove-bolt connection, a plug-in rotative connection can be made between the holding rod and the base body. Thus, a simple mounting and dismounting of the system can be provided. If the holding rods are disposed detachably on the base body, the base body can be inserted without the holding rods exclusively as a protector for the user's back.

The groove is preferably formed at one free end of the holding rod. The holding rod has, for example, a fork-shaped end or a joint fork, at the free end region by a groove.

The groove or the joint fork of the holding rod encloses the bolt at least partially. The diameter or the size of the groove and the diameter of the bolt at matched to one another in such a manner that a plug connection is formed. Furthermore, the plug connection can be configured as a clamping connection.

The plug connection can be configured in such a manner that the holding rod is disposed detachably on the base plate. The groove in the holding rod, for example, has two elastically deformable flanks which at least partially enclose the bolt. When a force is exerted which exceeds a pre-determined threshold value, the flanks of the groove can bend elastically so that the holding rod can be released from the bolt. Accordingly, by exerting, for example, a compressive force on the holding rod in the direction of the bolt, the groove can be plugged onto the bolt.

The bolt can be formed integrally and in one piece with the material of the base plate. Alternatively the bolt can form a separate component with respect to the base plate and be attached in a rotationally fixed or rotatable manner on the base plate.

According to a further exemplary embodiment, the base plate has a recess. The bolt is disposed in the recess. If the bolt is disposed in the recess, it can thus be avoided that the bolt forms a projecting and interfering component.

According to a further exemplary embodiment, the base plate has a stop. The stop is configured in such a manner that the holding rod impacts against the stop in a predetermined rotational position relative to the base plate.

The stop can, for example, be an element projecting from the surface of the base plate. If the bolt is disposed in the recess, the stop can be formed by an edge, which is formed in the transition between the beginning of the recess and the surface of the base body.

A pivoting movement of the holding rod is delimited by the stop. If, for example, a torsional force is applied to the holding rod although this is already abutting against the stop, the holding rod can be levered out and the groove can become detached from the bolt. Thus, in particular the safety of the system is increased overall since, for example, if the user falls onto the base plate, the holding rod can be released automatically from the base plate so that the risk of injury is reduced.

According to a further exemplary embodiment, the attachment device is attached in such a manner that a relative position of the attachment device relative to the holding rod is adjustable. The relative position describes a relative alignment or orientation of the attachment device to the holding rod. Furthermore, the relative position describes a certain distance of the attachment device from the holding rod.

For example, in one exemplary embodiment the system can have a universal coupling where the universal coupling attaches the attachment device to the holding rod in an articulated manner. The universal coupling can, for example, be a ball joint so that a relative position of the attachment device relative to the holding rod is adjustable.

The adjustability of the attachment device relative to the holding rod can, for example, be set by correspondingly adapted servomotors or by mechanical cable controls.

According to a further exemplary embodiment, the system further comprises a control device which is adapted in such a manner that the relative position is influencable by said device. The control device can automatically set the relative position of the attachment device, for example, based on measured accelerations, positional data or other measurement data. Furthermore the control device can receive control commands of the user in order to set the relative position of the attachment device starting from the control commands.

According to a further exemplary embodiment, the control device comprises an actuating device and coupling elements. The coupling elements couple the actuating device to the attachment device and/or the holding rod in such a manner that the relative position is adjustable by actuating the actuating elements. The actuating device is adapted in such a manner that the relative position of the attachment device relative to the holding rod can be input by the user.

The coupling elements can, for example, be cable controls consisting of a hemp cable or of a metal cable. The actuating device can, for example, comprise a pulley or a lever, whereby the coupling elements, such as for example the cable controls can be controlled (rolled up and unrolled). The coupling elements can, for example, be guided by the attachment device over the base plate along the holding rod to the attachment device.

According to a further exemplary embodiment, the control device is adapted to transmit control commands to the attachment device. The attachment device comprises at least one actuator. The actuator is adapted to receive control commands and set the relative position based on the control commands.

The actuator can, for example, be a servo motor or another drive unit whereby the attachment device is moved relative to the holding rod. The control commands can be transmitted in a wireless manner, for example, by radio, Bluetooth or other wireless transmission techniques or in a wired manner, e.g. by inserting a data cable between the actuator and the control device. The control device can further adapted in such a manner that a bidirectional data transmission is accomplished between the camera and the control device. Thus, for example the image field of the camera can be displayed on a display of the control device. Furthermore, a zoom factor and/or a sharpness setting of the camera image is adjustable by the control device.

The control device can, for example, comprise a mobile telephone, a (tablet) PC and/or another control device which is suitable for showing the camera image and transmitting control commands to the camera.

According to a further exemplary embodiment, the system further comprises another holding rod which is attached to the base plate at a distance from the holding rod. The attachment device is in each case attached to the holding rod and to the further holding rod. By a further holding rod to which the attachment device is attached with the base plate, a more stable attachment can be provided between the attachment device and the base plate. For example, three holding rods can be used in order, so to speak to produce a tripod or a support frame for the attachment device. Consequently each individual leg can in turn be made slimmer and therefore lighter since the transmitted forces are distributed over several holding rods.

The further holding rod can have the same properties and geometries as the holding rod described above.

According to a further exemplary embodiment, the holding rod and the further holding rod have different lengths. The holding rod and the further holding rod each have a free end. The free end of the holding rod and the further free end of the further holding rod each form the end of the respective holding rod which is furthest removed from the base plate. The end of the holding rod and the further end of the further holding rod are coupled to one another, for example.

If one holding rod is configured to be longer than the other holding rod and the end and the further end are coupled to one another, a position of the attachment device on which the camera is disposed is pivoted out laterally when viewed from a centre of the base plate. The camera disposed on the attachment device can thus record an image of the foreground of the user, for example, over the right and/or left shoulder of the user.

A more robust system is created by the arrangement of two, e.g. different-length holding rods since both holding rods support each other in a common coupling region. Furthermore, due to the different length of the holding rods, a different angular position of the attachment device or camera is adjustable relative to the base plate.

The two free ends of the holding rod is attachable to one another by a positive connection. Furthermore, the holding rods can be exchanged so that an alignment is also possible as a result of the different holding rod.

According to a further exemplary embodiment, the system further comprises a coupling device which couples the holding rod, in particular the free end thereof, and the further holding rod, in particular the further free end thereof, in a coupling region.

The coupling region, for example, forms the region at which the end of the holding rod and the further free end of the further holding rod are coupled. The coupling device can, for example, consist of a (e.g. detachable) coupling bolt which couples the holding rod and the further holding rod (detachably).

It is pointed out that embodiments of the invention have been described with reference to different inventive subject matters. In particular some embodiments of the invention are described with device claims and other embodiments of the invention are described with process claims. However, on reading this application, it will become immediately clear to the person skilled in the art that unless explicitly specified otherwise, in addition to one combination of features which belongs to one type of inventive subject matter, a combination of features which belong to different types of inventive subject matters is also possible.

### BRIEF DESCRIPTION OF THE DRAWINGS

Exemplary embodiments are described in detail in the following with reference to the appended drawings in order to further explain and for better understanding of the present invention. In the figures:

FIG. 1 shows a schematic diagram of a system for attachment of a camera to a user according to one exemplary embodiment of the present invention;

FIG. 2 shows a schematic diagram of a system for attachment of a camera to a user according to one exemplary embodiment of the present invention in which the holding straps are held together by clips;

FIG. 3 shows a schematic diagram of a system for attachment of a camera to a user according to one exemplary embodiment of the present invention, in which several different holding straps are shown for attachment of the base plate;

FIG. 4 shows a schematic diagram of a system for attachment of a camera to a user with two holding rods according to a further exemplary embodiment of the invention;

FIG. 5 shows a schematic diagram of the system for attachment of a camera to a user with two holding rods which are attached to the base plate by plug connection according to one exemplary embodiment of the present invention;

FIG. 6 shows a schematic diagram of the system for attachment of a camera to a user with one holding rod which is attached to the base plate by one bolt connection according to one exemplary embodiment of the present invention;

FIG. 7 shows a schematic diagram of the system for attachment of a camera to a user with two coupling rods on which the attachment device is disposed according to one exemplary embodiment of the present invention.

### DETAILED DESCRIPTION OF EXEMPLARY EMBODIMENTS

The same or similar components in different figures are provided with the same reference numbers. The diagrams in the figures are schematic.

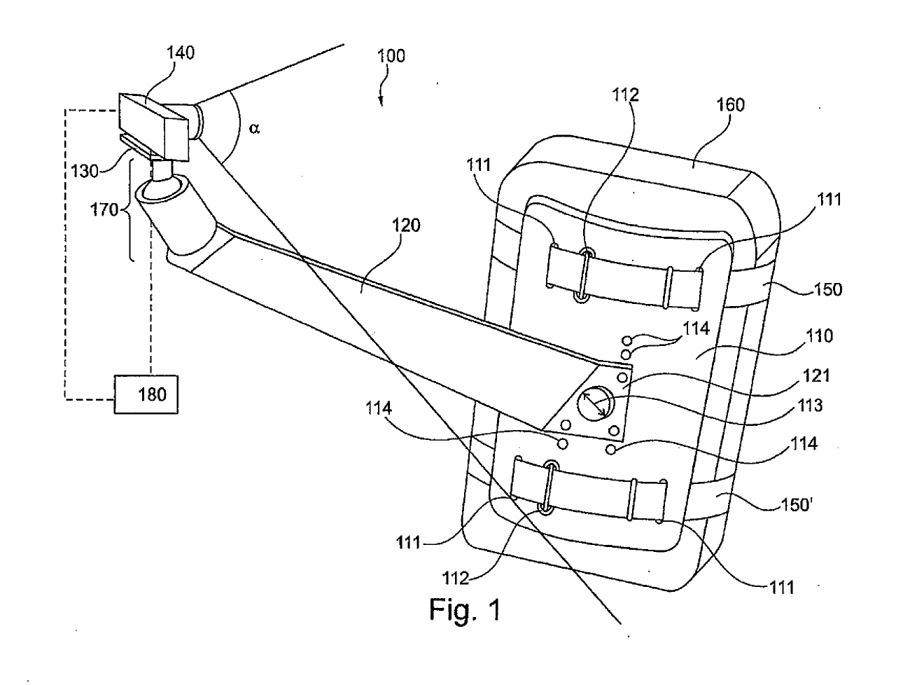

FIG. 1 shows a system 100 for attaching a camera 140 to a user. The system 100 comprises a base plate 110, a holding rod 120 and an attachment device 130. The holding rod 120 is attached to the base plate 110 and the attachment device 130 is attached to the holding rod 120. The attachment device 130 is configured in such a manner that the camera 140 is attachable to the attachment device in a desired alignment. The base plate 110 is configured in such a manner that this is attachable to a back device 160 which is attachable to a user's back.

FIG. 1 shows that on a rear side of the back device the base plate 110 is attached by holding straps 150, 150′. On a front side of the back device 160 opposite to the rear side, the back device 160 is attached to the back of the user, for example, by means of arm loops or waist straps. The back device 160 can, for example, comprise a back protector or a rucksack. The base plate 110 has a plurality of through openings 111 and/or loops 112. The holding straps 150, 150′ are threaded through the through openings 111 and through the loops 112. The holding straps 150, 150′ enclose the back device 160 so that the base plate 110 is attachable to the back device 160 with a firm seat.

It is clear from FIG. 1 that the base plate 110 forms a large supporting surface with the rear side of the back device 160. The base plate 110 can further have a curved profile so that the base plate 110 can nestle against the surface shape of the back device 160. Thus, forces can be transmitted more efficiently from the holding rod 120 via the base plate 110 to the back device 160. In particular, since the holding rod 120 overhangs towards the back (relative to the user), the weight force of the holding rod 120 and the weight force of the camera 140 produces a moment at the attachment point of the holding rod 120 to the base plate 110 and thus the back device 160. As a result of the flat configuration of the base plate 110, this moment can be transferred advantageously to the back device 160 which, in particular can consist of a soft material, without the holding rod 120 or the base plate 110 slipping away or turning away from the back device 160 as a result of the acting moment.

The holding rod 120 can be pivotably attached to the base plate 110 by a connecting means 113 such as, for example, a bolt or a stud. In addition, the base plate 110 can have holes 114 which are added at various distances from one another in the base plate 110. The connecting means 113 can for example be screwed into any hole 114 so that a desired position of the holding rod 120 on the base plate 110 is adjustable.

Furthermore, the holding rod 120 has a supporting surface 121. The supporting surface 121 is provided, for example by an angled part of the holding rod 120. As a result of the configuration of the supporting surface 121, a gentle transmission of force to the base plate 110 can be provided without packings being formed between the holding rod 120 and the base plate 110. A further supporting surface of the base plate 110 on the back device 160 can further be at least three times, four times or, for example, more than ten times as large as the cross sectional area of the cross section of the holding rod 120 and/or the supporting surface 121 of the holding rod 120 on the base plate 110.

Opposite the supporting surface 121, the holding rod 120 has the attachment device 130. A universal coupling 170 can be inserted between the attachment device 130 and the holding rod 120 so that the attachment device 130 is pivotable or movable with respect to the holding rod 120. The universal coupling 170 can, for example, consist of a ball joint having a spherical joint head and a corresponding joint socket.

The camera 140 is attached to the attachment device 130. The camera 140 is attachable to the attachment device 130, for example, by a detachable attachment means such as, for example, by a hook and loop closure or by holding loops. Furthermore the attachment device 130 can have a casing in which the camera 140 can be inserted for attachment.

FIG. 1 shows the angle of view α of the camera 140. The angle of view α is, for example, dependent on the objective of the camera 140 and its image settings. As shown in FIG. 1, the camera 140 is at a distance from the user's back. The angle of view a therefore comprises an image region which covers a part of the user from behind and furthermore the foreground (so-called reference foreground) or the panorama which is located in front of the user. The camera 140 can record individual images or film sequences. Due to the camera perspective which is obtained as a result of the system 100 according to the invention, in addition to recording the reference foreground, the movement sequences of the user can also be recorded. If the user is, for example a skier or a climber, the upper body during skiing or climbing generally remains in an almost vertical position, whereas the user's head frequently moves in the direction of movement of the user. Since the upper body stays in a stable, almost vertical, position and is not altered like the head of the user, for example, in the direction of the hill slope, the slope of the terrain can be imaged on a picture close to reality.

FIG. 1 shows a control device 180. The control device 180 is configured for controlling a relative position of the attachment device 130 relative to the holding rod 120 so that the user can control the alignment of the camera 140 by the control device 180. The control device 180 comprises, for example, an actuating device and coupling elements. The actuating device is set up, for example, in the gripping range of the user (or in the radius of action of the user's hands) where, from the actuating device, coupling elements such as, for example, cables are connected to the attachment device 130. The user can tighten the respective cables at the actuating device and thus set the desired position of the camera 140 or the relative position of the attachment device 130. The actuating device is, for example, a manual or electrically operated pulley.

Furthermore, the control device 180 can transmit control commands input by the user to actuators which are disposed, for example, in the universal coupling 170, on the attachment device 130 and/or on the holding rod 120. By the control device 180, the actuators can then be activated in response to the user's input and the relative position is adjustable.

The control device 180 can further comprise a display unit (display) in which the same image is displayed which is displayed by the camera and, for example, is determined by the angle of view α. The user can therefore identify the angle of view α and consequently the image to be recorded and specifically align the camera e.g., by the control device 180.

The control device 180 can, in this context, for example, be a mobile telephone on which a corresponding application or software is stored in order to trigger the actuators, for example, by means of a wireless connection (Bluetooth etc.). The camera can furthermore send image data to the control device 180.

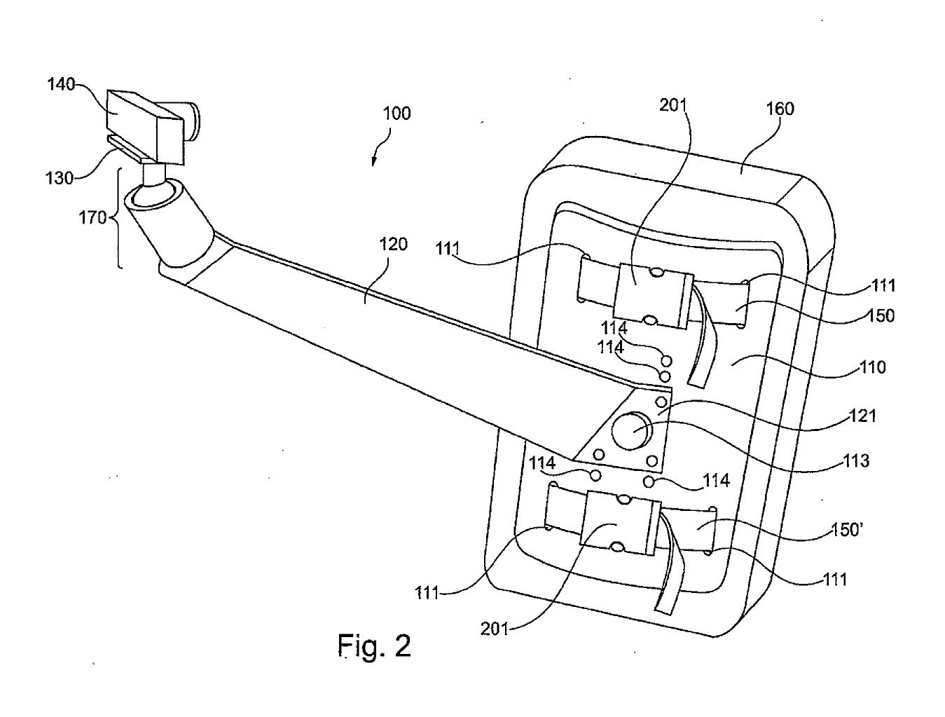

FIG. 2 shows another exemplary embodiment of the system 100. The system 100 in FIG. 2 has the same elements as the embodiment as in FIG. 1. Furthermore, the control device 180 shown in FIG. 1 can also be integrated in FIG. 2.

In addition, FIG. 2 shows holding straps 150, 150′ which run through corresponding through openings 111 of the base plate 110 in order to attach the baseplate 110 to the back device 160. For more rapid installation and attachment of the base plate 110 to the back device 160, the holding straps 150, 150′ have clips 201 with which the respective holding straps 150, 150′ can be detachably closed. In addition to a design of the holding straps 150, 150′ with the clips 201, ends of the holding straps 150, 150′ can also be coupled by a hook and loop closure, button closure or by a zip closure.

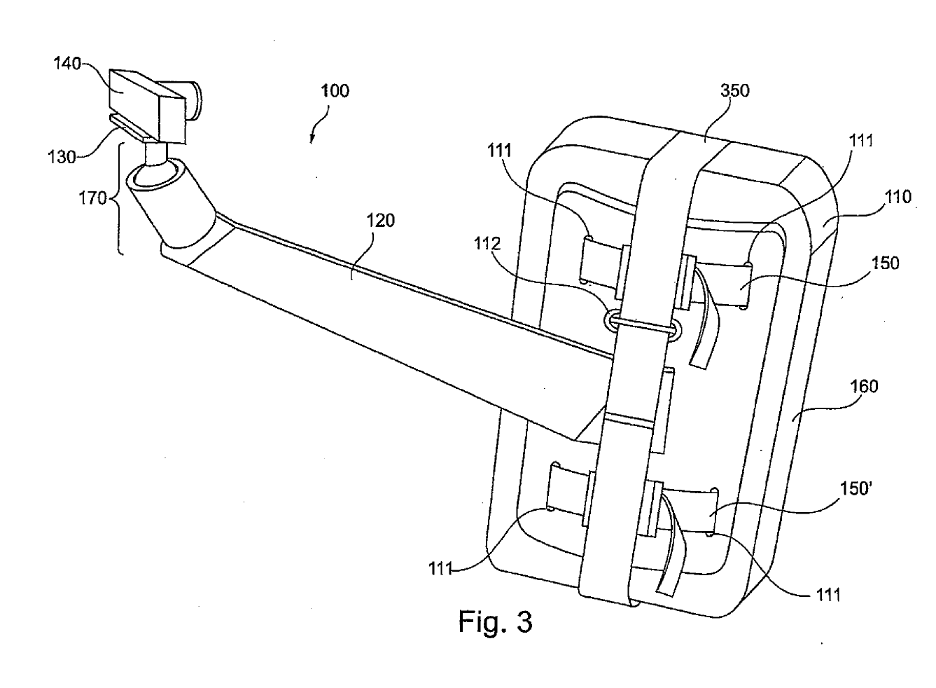

FIG. 3 shows an exemplary embodiment of the system 100. The system 100 in FIG. 3 has the same elements in FIG. 1 and FIG. 2. Furthermore the control device 180 shown in FIG. 1 can also be integrated in FIG. 3.

In addition, FIG. 3 shows a further holding strap 350 which runs substantially at right angles to the holding strap 150, 150′ along a surface of the base plate 110. Thus, a more stable seating of the base plate 110 on the back device 160 can be generated. The holding straps 150, 150′ and/or the further holding strap 350 can be firmly connected to the back device 160 or run around the back device 160 and the base plate 110 in order to achieve a type of press fit and a constriction at the back device 160.

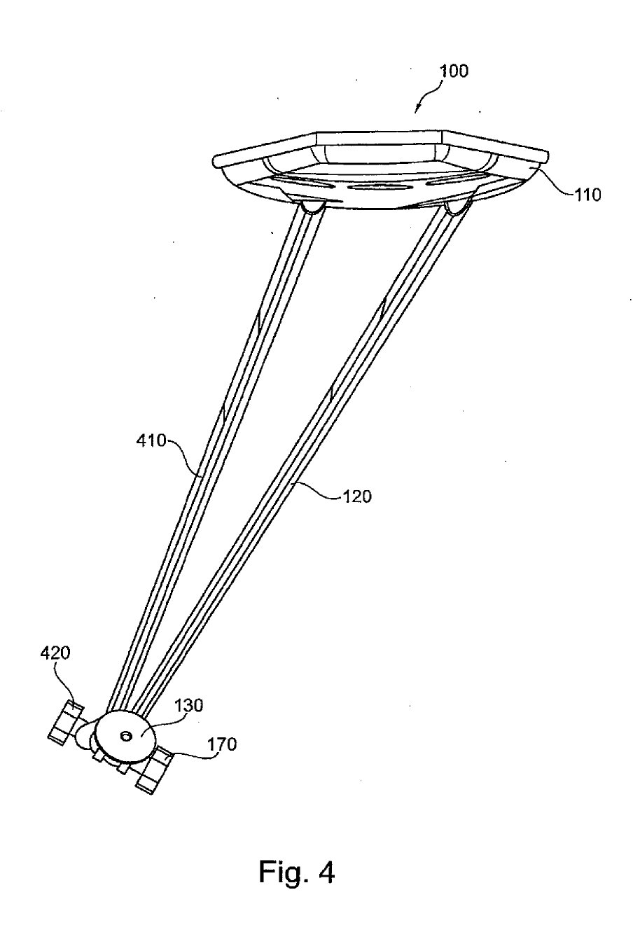

FIG. 4 shows a system 100 for fastening a camera 140 to a user according an exemplary embodiment of the present invention. The holding rod 120 and a further holding rod 410 are attached to the base plate. The holding rod 120 is in this case configured to be longer than the further holding rod 410. The holding rod 120 has a free end which is formed opposite to the end with which the holding rod 120 is attached to the base plate 110. Likewise, the further holding rod 410 has a further free end which is formed opposite to the end with which the further holding rod 410 is attached to the base plate 110.

The free end of the holding rod 120 is coupled to the free end of the further holding rod 410 by a coupling device 420. Since the holding rod 120 is longer than the further holding rod 410, the coupling region of the two holding rods 120, 410 at the respective free ends is displaced laterally outwards from a central region in relation to the base body 110. For example, the coupling region of the two free ends as shown in FIG. 4, is displaced to the left.

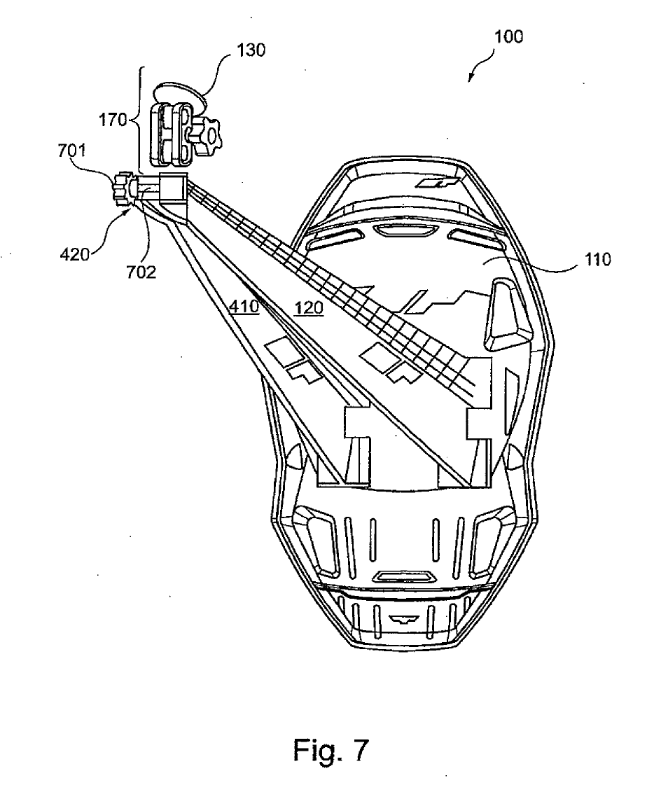

The coupling device 420, for example, comprises a coupling bolt 702 (see FIG. 7) which is attached by an actuating element 701 (see FIG. 7) to the respective ends of the holding rods 120, 410. Furthermore, the universal coupling 170 is located in the coupling region by which means the alignment of the attachment device 130 and therefore the camera alignment is adjustable flexibly.

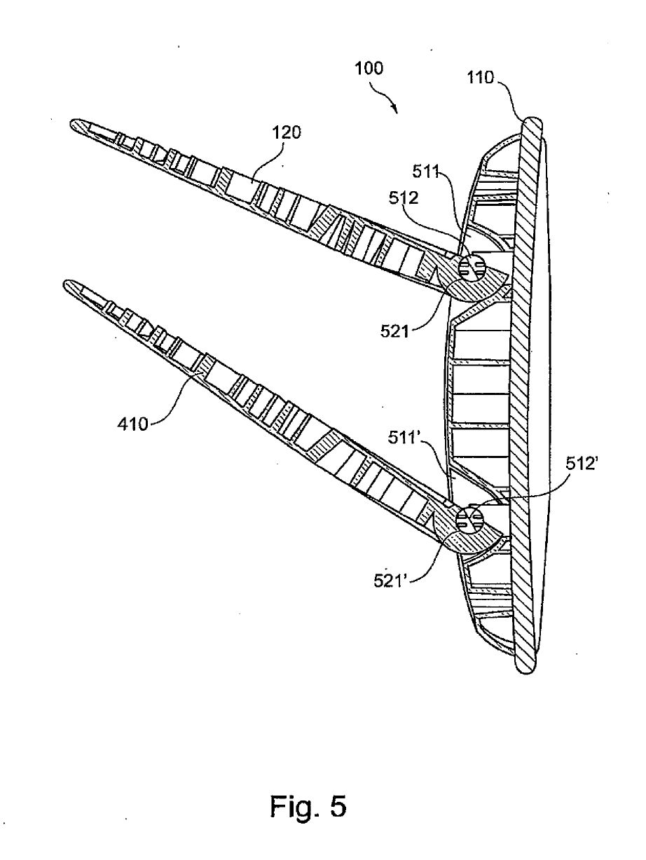

FIG. 5 shows a further exemplary embodiment of the present invention in which the holding rod 120 and the further holding rod 410 are attached to the base plate 110 by a plug connection on the base plate 110.

The holding rod 120 for example comprises a groove 521. In other words, the holding rod 120 forms a fork-shaped end by the groove 521. The holding rod 120 is plugged onto a bolt 512 by the groove 521. The groove 521 is configured in relation to the diameter of the bolt 512, for example, in such a manner that the bolt 512 is clamped in the groove 521. In other words a type of press fit is formed between the bolt 512 and the groove 521.

The plug connection between the holding rod 120 and the bolt 512 can additionally be configured in such a manner that the holding rod 120 is furthermore pivotable about an axis of rotation or about the bolt 512.

Accordingly, the further holding rod 410 is attached to a further bolt 512′ by a further groove 521′.

The bolts 512, 512′ can be disposed in corresponding recesses 511, 511′ of the base plate 110 in the base plate 110. The arrangement of the bolts 512, 512′ in the respective recesses 511, 511′ prevents the bolts from projecting from the base plate 110.

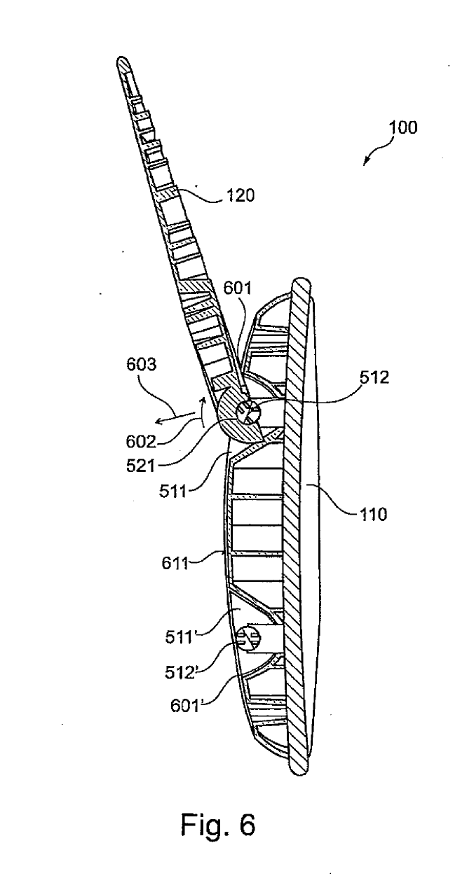

FIG. 6 shows an exemplary embodiment of the system 100 which has the same features as the system 100 from FIG. 5. FIG. 6 merely shows one holding rod 120 which is connected to the base plate 110. In particular, the base plate 110 from FIG. 6 has a stop 601. The holding rod 120 can impact against the stop 601 in a predetermined position so that a further rotation in the direction 602 is prevented.

The stop 601 can be an element projecting from the surface 611 of the base plate 110. On the other hand, as shown in FIG. 6, the stop 601 can be formed by an edge in the transition region between the surface 611 of the base body 110 and the recess 511.

The edge in particular forms the stop 601 when, as shown in FIG. 6, the bolt 512 is disposed inside the base plate 110, i.e. in the recess 511 and thus at a distance from the surface 611 in the base plate 110. If, for example, the holding rod 120 turns in the direction 602, on contact of the holding rod 120 with the stop 601 a centre of revolution is formed at said stop. During a further rotation 602 about the centre of revolution at the stop 601, a lever force is formed with a lever direction 603. This lever force in the lever direction 603 has the result that the plug connection between the groove 521 and the bolt 512 is released and the plug connection between the holding rod 120 and the base plate 110 is thus released.

A safety measure is thus provided since if the user falls on the base plate 110, the holding rod 120 releases automatically. The risk of injury by the system 100 as a result of a fall of the user can thus be reduced.

Accordingly an edge 601′ can be formed in the transition between the surface 611 and the recess 511′ so that a further holding rod 410 (not shown in FIG. 6 for better clarity) can also be released from the bolt 512′ in the event of a fall.

FIG. 7 shows a perspective view of the system 100 for attachment of a camera 140 with a holding rod 120 and a further holding rod 410. The holding rods 120, 410 are pivotably mounted on the base plate 110. For example, the holding rods 120, 410 are pivotably disposed on the base body 110 at corresponding bolts as shown in FIG. 5 and FIG. 6. At the free end of the holding rod 120 and the further free end of the further holding rod 410 a coupling bolt 702 passes through the holding rod 120 and the further holding rod 410. Furthermore, the universal coupling 170 is attachable to the coupling bolt 702. The coupling bolt 702 can be detachably attached by an actuating element 701. The alignment of the attachment device 130 can be adjusted by the universal coupling 170.

The free ends can be braced to one another by the actuating element 701 and the coupling bolt 702. Grooves can also be provided in the free ends which at least partially enclose the coupling bolt. As a result of the bracing by the actuating element 701, it is possible to fix the free ends by the coupling bolt 702. If the actuating element 701 (such as, for example. a tensioning screw) is loosened, both holding rods 120, 410 can be released from one another. It is not necessary to completely unscrew the coupling bolt 702.

In addition, it should be noted that “comprising” does not exclude any other elements or steps and “one” or “a” does not exclude a plurality. It is further noted that features or steps which have been described with reference to one of the above exemplary embodiments can also be used in combination with other features or steps of other exemplary embodiments described above. Reference numbers in the claims should not be seen as a restriction.

### REFERENCE LIST

100 System
110 Base plate
111 Through opening
112 Loop
113 Connecting means
114 Hole
120 Holding rod
121 Supporting surface
130 Attachment device
140 Camera
150 Holding strap
160 Back device
170 Universal coupling
180 Control device
201 Clip
350 Further holding strap
410 Further holding rod
420 Coupling direction
511 Recess
512 Bolt
521 Groove
601 Stop
602 Direction of rotation
603 Lever direction
611 Surface of base plate
701 Actuating element
702 Coupling bolt
α Angle of view

1-15. (canceled)

16. System for mounting a camera on a user, the system comprising
a base plate,
a holding rod attached to the base plate, and
an attachment device attached to the holding rod,
wherein the attachment device is configured in such a manner that the camera is attachable thereon and
wherein the base plate is configured in such a manner that this is attachable to a back device which is attachable to a user's back.

17. The system according to claim 16,
wherein the base plate has at least one through opening and/or at least one loop.

18. The system according to claim 16,
wherein the holding rod is attached pivotally to the base plate.

19. The system according to claim 18,
wherein the holding rod and the base plate configure a plug connection in such a manner that the holding rod is pivotable about the bolt.

20. The system according to claim 19,
wherein the base plate has a recess wherein the bolt is disposed in the recess.

21. The system according to claim 19,
wherein the base plate has a stop which is configured in such a manner that the holding rod impacts against the stop in a predetermined rotational position relative to the base plate.

22. The system according to claim 16,
wherein the attachment device is attached to the holding rod in such a manner that a relative position of the attachment device relative to the holding rod is adjustable.

23. The system according to claim 16, further comprising a universal coupling,
wherein the universal coupling attaches the attachment device to the holding rod in an articulated manner so that a relative position of the attachment device relative to the holding rod is adjustable.

24. The system according to claim 22, further comprising
a control device which is adapted in such a manner that the relative position is influencable by said device.

25. The system according to claim 24,
wherein the control device comprises an actuating device and coupling elements, wherein the coupling elements couple the actuating device to the attachment device and/or the holding rod in such a manner that the relative position is adjustable by actuating the actuating elements.

26. The system according to claim 24,
wherein the control device is adapted to transmit control commands to the attachment device,
wherein the attachment device comprises at least one actuator and
wherein the actuator is adapted to receive control commands and set the relative position based on the control commands.

27. The system according to claim 16, further comprising
another holding rod which is attached to the base plate at a distance from the holding rod, wherein the attachment device is attached to the holding rod and to the further holding rod.

28. The system according to claim 27,
wherein the holding rod and the further holding rod have different lengths.

29. The system according to claim 27, further comprising
a coupling device which couples the holding rod and the further holding rod to a coupling region which is located at a distance from the base plate.

30. Method for imaging a user, the method comprising
recording an image of a user by a camera,
wherein the camera is attached to an attachment device,
wherein the attachment device is attached to a holding rod,
wherein the holding rod is attached to a base plate and wherein the base plate is attached to a back device attached to a user's back.
